(19) United States
(12) Patent Application Publication
(10) Pub. No.: US 2012/0158868 A1
(43) Pub. Date: Jun. 21, 2012

(54) PROTECTING PRIVACY IN GROUPS E-MAIL MESSAGES

(75) Inventors: R. Preston McAFEE, San Marino, CA (US); Raghu Ramakrishnan, Saratoga, CA (US)

(73) Assignee: Yahoo! Inc, Sunnyvale, CA (US)

(21) Appl. No.: 12/973,952

(22) Filed: Dec. 21, 2010

(51) Int. Cl. G06F 15/16

(52) U.S. Cl. 709/206

(57) ABSTRACT

Protecting privacy in groups e-mails messages. A method includes the step of receiving an e-mail message having one or more intended recipients. The method also includes the step of comparing content of the e-mail message against content of previous e-mail messages. Further, the method includes the step of flagging the e-mail message. In another embodiment, a computer program product stored on a non-transitory computer-readable medium when executed by a processor, performs the method for verifying intended recipients of an e-mail message with anomalous content. In yet another embodiment, a system to verify intended recipients of an e-mail message with anomalous content includes an e-mail interface and a content analyzer.

### BACKGROUND

1. Technical Field

Embodiments of the invention relate generally to the field of computer networking, and more specifically, to e-mail content filtering.

2. Prior Art

One of the most common and effective ways of communication is through electronic mail (e-mail) messages. An e-mail message allows users to exchange information digitally across the Internet or other networks. An e-mail message consists of two essential parts, a message header and a message body. The message header includes one or more recipients' addresses. Additional information may be added, for example, “subject”, “Cc” and “Bcc”. Further, the message body s is the content of the e-mail.

Often, when users send e-mail messages (in short, “emails”) to a plurality of recipients, there is a risk of sending the e-mail to unintended recipients. For example, a user intends to send an e-mail to his co-workers, Frank Augustine, Daniel Jones and Mark Robert. As the user types “Frank” in the header, the address of “Frank Anderson” can be displayed along with “Frank Augustine”, since e-mail applications such as Yahoo! Mail predict the intended recipient. In such a scenario, the user may accidentally select the recipient “Frank Job” instead of “Frank Augustine”. The situation worsens with email sent to a large group of recipients, wherein the user may inadvertently send a message that is not appropriate for all recipients. Hence, communication privacy is hindered by sending e-mails to unintended recipients.

In light of the foregoing discussion, there is a need for an efficient method and system for verifying intended recipients of an e-mail message in which anomalous content has been identified.

### SUMMARY

Embodiments of the present disclosure described herein provide a method, a computer program product and system for verifying intended recipients of an e-mail message in which anomalous content has been identified.

An example of a computer-implemented method for verifying intended recipients of an e-mail message with anomalous content includes the step of receiving an e-mail message having one or more intended recipients. The method also includes the step of comparing content of the e-mail message against content of previous e-mail messages. Further, the method includes the step of flagging the e-mail message.

An example of a computer program product stored on a non-transitory computer-readable medium that when executed by a processor, performs a method for verifying intended recipients of an e-mail message with anomalous content that includes the step of receiving an e-mail message having one or more intended recipients. The method also includes the step of comparing the content of the e-mail message against the content of previous e-mail messages sent by the same user. Further, the method includes the step of flagging the e-mail message.

An example of a system for verifying intended recipients of an e-mail message with anomalous content includes an e-mail interface. Further, the system includes a content analyzer coupled to the e-mail interface.

Advantageously, the risk of sending e-mails to unintended recipients is decreased.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 is a flow diagram illustrating a method for verifying intended recipients of an e-mail message with anomalous content according to one embodiment;

FIG. 2 is a flow diagram illustrating a method for searching the e-mail database according to one embodiment;

FIG. 3 shows exemplary search results from the e-mail database for a particular group of recipients according to one embodiment;

FIG. 4 is a block diagram of an exemplary e-mail system according to one embodiment.

### DETAILED DESCRIPTION OF THE EMBODIMENTS

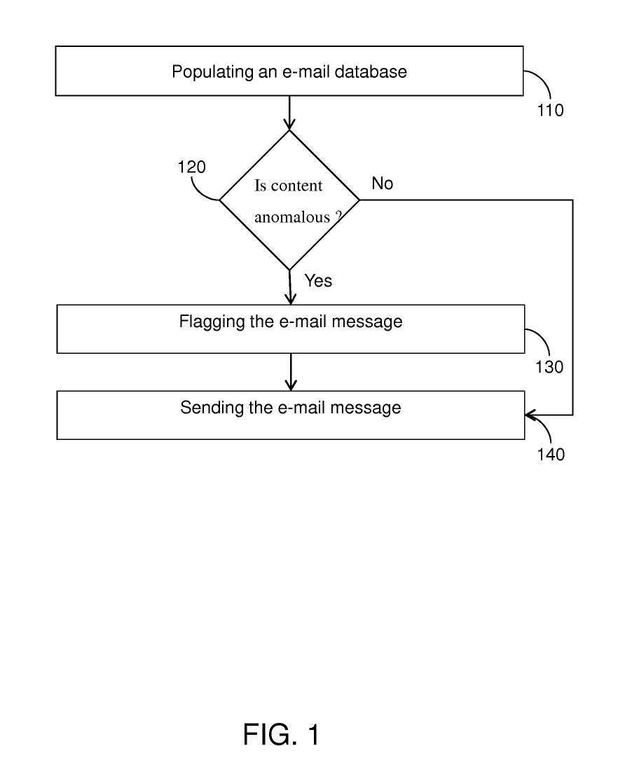

FIG. 1 is a flow diagram illustrating a method 100 for verifying intended recipients of an e-mail message with anomalous content according to one embodiment of the present invention.

At step 110, an e-mail database is populated. E-mails (or other communications such SMS messages) sent or received from a user or organization are analyzed relative to a recipient or group of recipients (references to an e-mail sent to a recipient herein can also apply to a group of recipients) of the e-mail. For each recipient, a database entry is added along with characteristics of the e-mail. Exemplary characteristics include tone, frequent words or phrases, topics of discussion, and other distinguishing parameters that are typical of communications with the recipient.

In one embodiment, each recipient is characterized by a histogram. The histogram records frequencies of certain terms and/or phrases that appear in e-mails to a recipient. For example, a user may correspond with a tax accountant, resulting in phrases such as “expenses”, “income”, “April”, and “deductions”. On the other hand, the same user may be part of a fantasy football group, exchanging e-mails containing phrases such as “football players”, “points”, “Sunday” and “trade”.

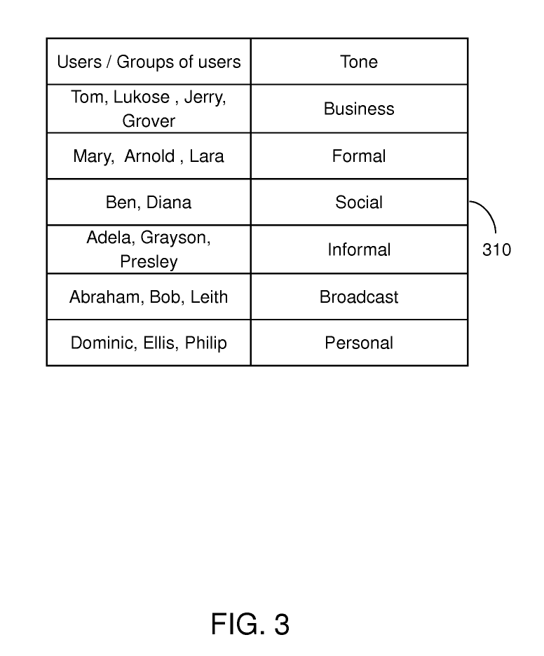

At step 120, an outgoing e-mail is compared against entries of the database to identify anomalous content based on an intended recipient. This step is described in further detail below with respect to FIG. 3. If the content is anomalous, step 130 is performed. If the content is not anomalous, step 140 is performed.

At step 130, the e-mail message is flagged. At this point, a sender can be asked to verify whether the e-mail should be sent to the recipient indicated. In one implementation, a pop-up window is spawned to alert the sender. In another implementation, a recipient that may be unintended can be highlighted to draw the sender's attention. At this point, the unintended recipient (or anomalous content) can be removed.

At step 140, the e-mail message is sent to one or more intended recipients after verification is completed.

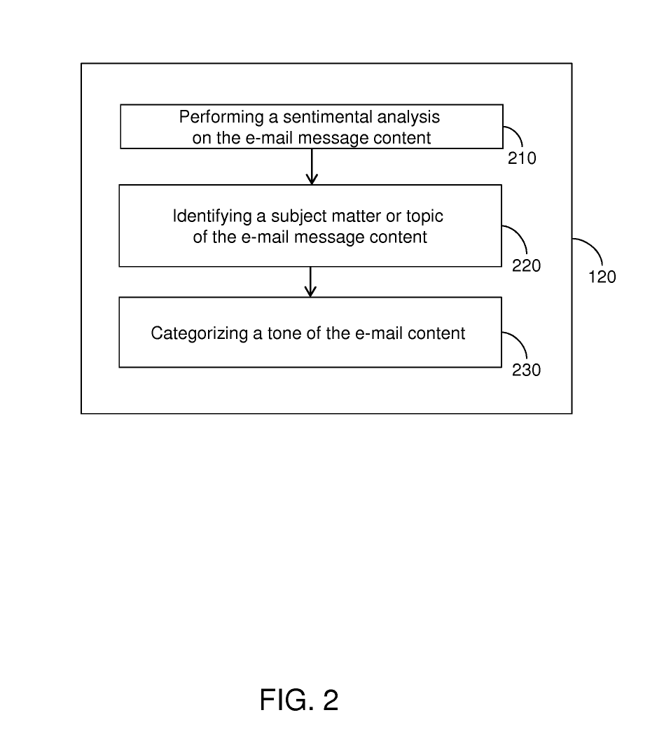

FIG. 2 is a flow diagram illustrating a method 120 for comparing an outgoing e-mail to identify anomalous content based on an intended recipient according to one embodiment. The embodiment of FIG. 2 represents an exemplary analysis for identifying anomalous content. In other implementation-specific embodiments, the steps may occur in a different order. In still other embodiments, just one of the steps can be performed, or additional steps not listed can be performed.

At step 210, a sentiment analysis is performed on the e-mail message content to determine appropriateness relative to an intended recipient. Sentiment analysis is a method of natural language processing which aims to determine the emotional state of the user while writing a text. For example, a sentiment analysis can identify an angry or sexual disposition of e-mail content. As a result, an e-mail message having an awkward sentiment for an intended recipient can be identified.

At step 220, a subject matter or topic of the e-mail message content is identified. The subject matter or topic of the e-mail message is compared with the previous subject matter or topics. In one embodiment, the subject matter or topic is taken from the subject line of an e-mail header. In another embodiment, the totality of content is summarized with a few key words.

At step 230, a tone of the e-mail content is categorized. The e-mail content is compared with the previous e-mail messages. A tone is assigned to the e-mail content. The tone signifies the emotional state of the user while writing. Examples of the tone are business, formal, social, informal, broadcast or personal. For example, the e-mail content is assigned a tone of business since the message content consists of terms or phrases related to a teleconference call.

FIG. 3 illustrates a table 310 of exemplary search results from the e-mail database for a particular group of recipients according to one embodiment.

The rows correspond to users or group of users. The columns correspond to a tone. For example, a group including “Tom, Lukose, Jerry and Grover” has been assigned a “Business” tone. Similarly, “Ben” and “Diana” fall into the group of “Social”. Thus the search results give a range of typical recipients with whom the user may want to communicate frequently. In other embodiments, the rows may correspond to different parameters, for example, sentiment, word and/or phrases, or topics.

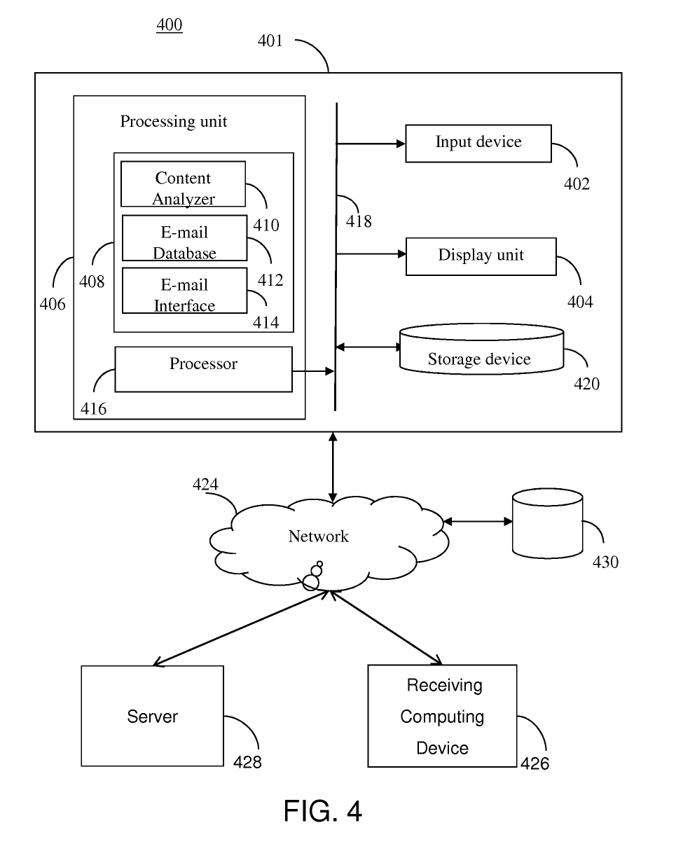

FIG. 4 is a block diagram of an exemplary e-mail system 400 upon which various embodiments of the invention may be implemented. A network 424 (e.g., the Internet, a LAN, a WAN, or the like) couples a sending computing device 401 with a receiving computing device 426, a server 428 and a database 430.

The sending computing device 401 and the receiving computing device 426 can be any processor based device capable of sending and or receiving e-mails (e.g., a personal computer, a mobile computing device, a laptop computer, a PDA, a smart phone, etc.). Further, the sending computing device 401 include a processing unit 406 including a main memory 408, such as a Random Access Memory (RAM) or other dynamic storage device, coupled to a bus interface 418 for storing information and instructions to be executed by processor 416. The main memory 408 includes a content analyzer 410, an e-mail database 412 and e-mail interface 414. The content analyzer 410 is coupled to the e-mail interface 414 to identify anomalous content in e-mails. The e-mail interface 414 receives an e-mail message having one or more intended recipients and display flags to signify an anomalous content. The e-mail database 412 stores characteristics of e-mails communicated by the user. The above components can be implemented in software, hardware, or by a combination of both.

In the present embodiment, the e-mail database 412 is locally located (e.g., as when implemented in a local e-mail application such as Microsoft Outlook). In another embodiment, the e-mail database can be remotely stored, for example, on the database 430 (e.g., when implemented in a remote or web-based application such as Yahoo! Mail). A storage device 420, such as a magnetic disk or optical disk, is provided and coupled to the bus interface 418 for storing information and instructions. The sending computing device 401 may be coupled via the bus interface 418 to a display 404 for displaying information to a user. An input device 402, including alphanumeric and other keys, is coupled to bus interface 418 for communicating information and command selections to processor 416.

A user of the sending computing device 401 accesses an application, for example a website or Yahoo! Mail. The user inputs a message to be sent to a recipient of the receiving computing device 426. In one embodiment, the e-mail can be communicated to a group of recipients through the server 428. For each recipient, a database entry is added with the characteristics of the e-mail. Further, the e-mail is compared with the previous entries in the e-mail database 412, to identify anomalous content. If the content is anomalous, the e-mail interface 414 flags the message. The user is then asked to verify the intended recipient. Upon verification, the e-mail is sent to the receiving computing device 426.

Embodiments of the invention are related to the use of e-mail system 400 for implementing the techniques described herein. In an embodiment of the invention, those techniques are performed by e-mail system 400 in response to processor 416 executing one or more sequences of one or more instructions included in main memory 408. Such instructions may be read into main memory 408 from another machine-readable medium product, such as storage device 420. Execution of the sequences of instructions included in main memory 408 causes processor 416 to perform the method embodiment of the invention described herein. In alternative embodiments, hard-wired circuitry may be used in place of or in combination with software instructions to implement the invention. Thus, embodiments of the invention are not limited to any specific combination of hardware circuitry and software.

The term “machine-readable medium product” as used herein refers to any medium that participates in providing data that causes a machine to operation in a specific fashion. Examples of the machine-readable medium product include but are not limited to memory devices, tapes, disks, cassettes, integrated circuits, servers, online software, download links, installation links, and online links.

The foregoing description sets forth numerous specific details to convey a thorough understanding of embodiments of the invention. However, it will be apparent to one skilled in the art that embodiments of the invention may be practiced without these specific details. Some well-known features are not described in detail in order to avoid obscuring the invention. Other variations and embodiments are possible in light of above teachings, and it is thus intended that the scope of invention not be limited by this Detailed Description, but only by the following Claims.

What is claimed is:

1. A computer-implemented method for verifying intended recipients of an e-mail message with anomalous content, comprising:
receiving an e-mail message having one or more intended recipients;
comparing content of the e-mail message against content of previous e-mail messages sent to the one or more intended recipients to identify anomalous content; and
responsive to identifying anomalous content, flagging the e-mail message.

2. The method of claim 1, wherein comparing content comprises:
performing a sentiment analysis on the e-mail message content for comparison against sentiment analysis of the previous e-mail messages content.

3. The method of claim 1, wherein the comparing content comprises:
identifying a subject matter or topic of the e-mail message content for comparison against subject matters or topics of the previous e-mail messages content.

4. The method of claim 1, wherein the comparing content comprises:
categorizing a tone of the e-mail message content for comparison against tone categorizations of the previous e-mail messages content.

5. The method of claim 4, wherein the tone is characterized by one of: business, formal, social, informal, broadcast, or personal.

6. The method of claim 1, further comprising:
generating a histogram of terms or phrases from the previous e-mail messages content,
wherein comparing content comprises estimating a probability that terms or phrases of the e-mail content indicate an anomaly.

7. The method of claim 1, wherein flagging the e-mail message comprises:
querying a user for verification that the e-mail message should be sent.

8. A computer program product stored on a non-transitory computer-readable medium that when executed by a processor, performs a method for verifying intended recipients of an e-mail message with anomalous content, comprising:
receiving an e-mail message having one or more intended recipients;
comparing content of the e-mail message against content of previous e-mail messages sent to the one or more intended recipients to identify anomalous content; and
responsive to identifying anomalous content, flagging the e-mail message.

9. The method of claim 8, wherein comparing content comprises:
performing a sentiment analysis on the e-mail message content for comparison against sentiment analyses of the previous e-mail messages content.

10. The method of claim 8, wherein the comparing content comprises:
identifying a subject matter or topic of the e-mail message content for comparison against subject matters or topics of the previous e-mail messages content.

11. The method of claim 8, wherein the comparing content comprises:
categorizing a tone of the e-mail message content for comparison against tone categorizations of the previous e-mail messages content.

12. The method of claim 8, wherein the tone is characterized by one of: business, formal, social, informal, broadcast, or personal.

13. The method of claim 8, further comprising:
generating a histogram of terms or phrases from the previous e-mail messages content,
wherein comparing content comprises estimating a probability that terms or phrases of the e-mail content indicate an anomaly.

14. The method of claim 8, wherein flagging the e-mail message comprises:
querying a user for verification that the e-mail message should be sent.

15. A system for verifying intended recipients of an e-mail message with anomalous content, comprising:
an e-mail interface to receive an e-mail message having one or more intended recipients;
a content analyzer, coupled to the e-mail interface, the content analyzer to compare content of the e-mail message against content of previous e-mail messages sent to the one or more intended recipients to identify anomalous content; and
wherein responsive to identifying anomalous content, the e-mail interface flags the e-mail message.

16. The system of claim 15, the content analyzer performs a sentiment analysis on the e-mail message content for comparison against sentiment analyses of the previous e-mail messages content.

17. The system of claim 15, wherein the content analyzer identifies a subject matter or topic of the e-mail message content for comparison against subject matters or topics of the previous e-mail messages content.

18. The system of claim 15, wherein the content analyzer categorizes a tone the e-mail message content for comparison against tone categorizations of the previous e-mail messages content.

19. The system of claim 18, wherein the tone is characterized by one of: business, formal, social, informal, broadcast, or personal.

20. The system of claim 15, wherein the content analyzer generates a histogram of terms or phrases from the previous e-mail messages content, and estimates a probability that terms or phrases of the e-mail content indicate an anomaly.

21. The system of claim 15, wherein the e-mail interface queries a user for verification that the e-mail message should be sent.
